(19) United States
(12) Patent Application Publication
(10) Pub. No.: US 2012/0301854 A1
(43) Pub. Date: Nov. 29, 2012

(54) COMPUTER PROGRAM, METHOD, AND SYSTEM FOR PHYSICIAN LEARNING AND REFERENCE CONTENT

(75) Inventor: Robert E. Vann, JR., Leawood, KS (US)

(73) Assignee: MEDPRODIGY, INC., Overland Park, KS (US)

(21) Appl. No.: 13/478,594

(22) Filed: May 23, 2012

Related U.S. Application Data
(60) Provisional application No. 61/490,170, filed on May 26, 2011.

(51) Int. Cl. G09B 19/00

(52) U.S. Cl. 434/219

(57) ABSTRACT

A computer program, method, and system for compiling medical treatment information and displaying the information based on a user's selection of a program mode. In embodiments of the present invention, the medical treatment information is comprised of medical reference material and supplier solution materials. The medical treatment information is displayed a format that allows for medical practitioner accreditation by the Accreditation Council for Continuing Medical Education (ACCME) and that does not violate regulations imposed by the Federal Drug Administration (FDA).

### RELATED APPLICATIONS

This patent application claims priority benefit, with regard to all common subject matter, of earlier-filed U.S. Provisional Patent Application No. 61/490,170, filed May 26, 2011, and entitled “METHOD AND COMPUTER SOFTWARE FOR PHYSICIAN LEARNING AND REFERENCE CONTENT.” The identified earlier-filed provisional patent application is hereby incorporated by reference in its entirety into the present application.

### FIELD

Embodiments of the present invention provide a computer program, method, and system for compiling medical treatment information and displaying various categories of the information in response to a user's selection of a program mode. More particularly, embodiments of the present invention provide for medical treatment information to be displayed in a format that allows for medical practitioner accreditation by the Accreditation Council for Continuing Medical Education (ACCME) and that does not violate regulations imposed by the Federal Drug Administration (FDA).

### BACKGROUND

Physicians are required to annually obtain a certain number of continuing educational hours, referred to as Continuing Medical Education (“CME”). The ACCME institutes protocols and standards for the CME programs administered to physicians. One standard requires that any CME program must be independent and that any commercial sponsor of the program not control or otherwise influence the program content.

The requirement for impartiality arises because of a concern that physicians who attend commercially-sponsored CME courses to fulfill their accreditation requirements could be exposed to influences from pharmaceutical and medical device companies (hereinafter “commercial suppliers”). The physicians could then be improperly swayed in their treatment methods. For example, if the physician is attending a CME course on how to treat a particular medical issue, and the only method of treatment discussed in the CME or otherwise emphasized is a treatment method supplied by the commercial supplier sponsoring the CME, then the physician may be unknowingly influenced to be biased for the discussed method of treatment. Alternatively, the physician may not be supplied with all potential treatment methods and instead incorrectly believe that the only available treatment method is the particular method provided by the commercial supplier sponsoring the CME. To insure that commercial suppliers sponsoring CMEs are not biasing the physician's preferred method of treatment, while still allowing the physician the opportunity to learn about new treatment methods, the ACCME requires that the CME programs' content be free of sponsor control.

Influence of physician treatment methods by commercial suppliers is so problematic that the Federal Drug Administration (“FDA”) has implemented restrictions on how and the extent to which commercial suppliers may interact with physicians. Since 2009 the Department of Justice, in enforcing violations of the Food Drug and Cosmetic Act, recovered approximately $3.9 billion in settlements from commercial suppliers for improper contact or other violations of the FDA proscriptions on supplier influence. Moreover, research reflects an increasing patient awareness of gratuitous supplier marketing tactics, which in turn makes the patient suspicious of physician motivation for the selected treatment method. Physicians are also becoming more conscious of their unbiased image in challenging the objectivity of CME content and physician spokespersons.

Notwithstanding the above problems with improper commercial supplier influence, the need to educate physicians about new treatment methods, which are often rapidly evolving, is paramount to proper patient care. Thus, there is a dichotomy between physician education of new treatment methods and undue influence by commercial suppliers that provide the new treatment methods.

### SUMMARY

Embodiments of the present invention solve the above-mentioned problems by providing a computer program, a method, and a system that compiles medical treatment information and displays various categories of the information in response to a user's selection of a program mode. The displaying of medical treatment information is in a format that conforms to standards imposed by the FDA and ACCME. Embodiments of the present invention utilize the content and collaboration inventions set forth in U.S. Pat. No. 7,014,470, which has a common inventor with the present application. The disclosure of the '470 patent is hereby incorporated by reference in its entirety.

The medical treatment information compiled by the present invention may be displayed for medical reference purposes or for CME purposes. If the medical treatment information is displayed for medical reference purposes, then all types of medical treatment information, including medical reference material and supplier solution material, are available for display. However, if the medical treatment information is displayed for CME purposes, then only medical reference material is displayed. Thus, because the supplier solution material cannot be displayed while the computer program is displaying medical treatment information for CME purposes, the present invention is able to display medical information while complying with the impartiality requirements imposed by the FDA and the ACCME.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE DRAWING FIGURES

Embodiments of the present invention are described in detail below with reference to the attached drawing figures, wherein:

FIG. 1 is a schematic depiction of a system for compiling medical treatment information and displaying various categories of the information in response to a user's selection of a program mode;

FIG. 2 is a flow chart of a method of compiling and displaying medical treatment information; and

FIG. 3 is a depiction of medical treatment information being displayed by an embodiment the present invention.

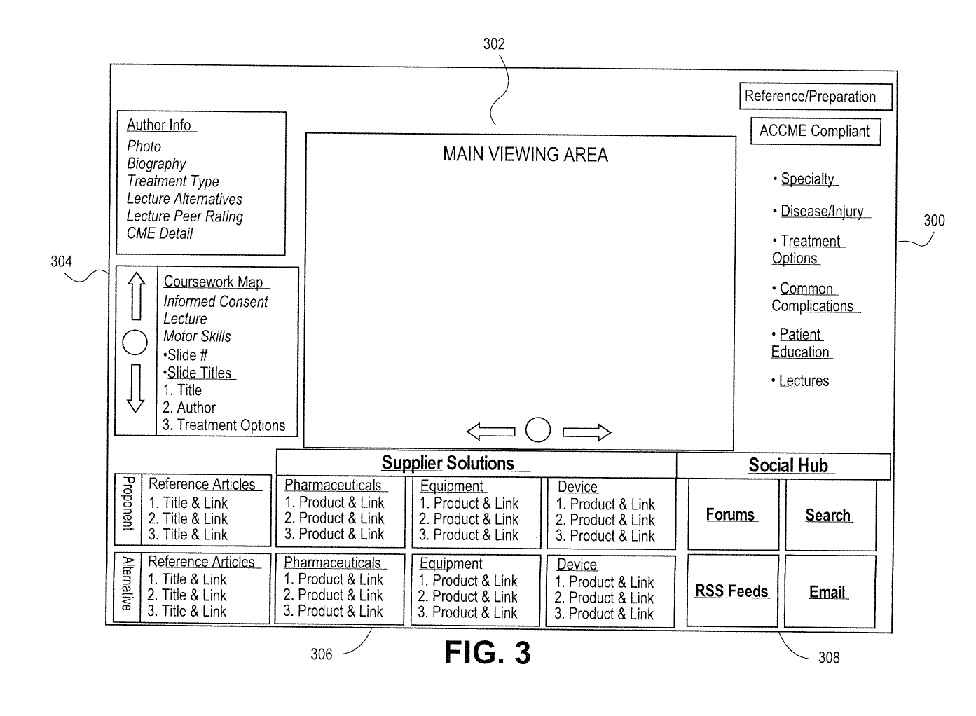

The drawing figures do not limit the present invention to the specific embodiments disclosed and described herein. The drawings are not necessarily to scale, emphasis instead being placed upon clearly illustrating the principles of the invention.

### DETAILED DESCRIPTION OF THE EMBODIMENTS

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

The present invention provides various embodiments of a computer program, a method, and a system for compiling and displaying medical treatment information to a user via an electronic resource, such as an online website or mobile application. Depending on the purpose and desire of the user in viewing the medical treatment information, the present invention limits or otherwise selects the type and amount of medical treatment information presented to the user. As a non-limiting example, the user may choose to view information in a first program mode, such as a continuing education mode, wherein the presentation of information is limited so as to conform with ACCME requirements. As another non-limiting example, the user may choose to view information in a second program mode, such as a medical reference mode, wherein the presentation of information is not limited and the user can view all compiled information for a particular medical issue.

The computer program of embodiments of the present invention comprises a plurality of codes segments executable by a computing device for performing the steps of the method of the present invention. The user of the present invention can selectively activate a program mode for desired operational features. The present invention includes at least two programs modes, namely a medical reference mode and a continuing education mode. In further embodiments of the present invention, a third program mode, referred to as a compliance mode, may also be selected by the user. Depending on the activated program mode, the computer program and system of the present invention displays certain medical treatment information to the user. In preferred embodiments of the present invention, the users of the computer program are physicians. However, in other embodiments, users may include patients, academic medical centers, physician membership organizations, or other medical related entities.

The computer program, method, and system of embodiments of the present invention comprises the initial step of compiling medical treatment information, including medical reference material and supplier solution material. In the next step, the user is provided with an option to view the medical treatment information in either a continuing education mode or in a medical reference mode. The user selects the desired program mode, and embodiments of the present invention receive information indicative of the selection by the user. Upon receipt of the user's selection to view the medical treatment information in a medical reference mode, embodiments of the present invention display both the medical reference material and supplier solution material. Alternatively, upon receipt of the user's selection to view the medical treatment information in the supplier solution mode, embodiments of the present invention display only the medical reference material and will not make the supplier solution material available for display.

### System Description

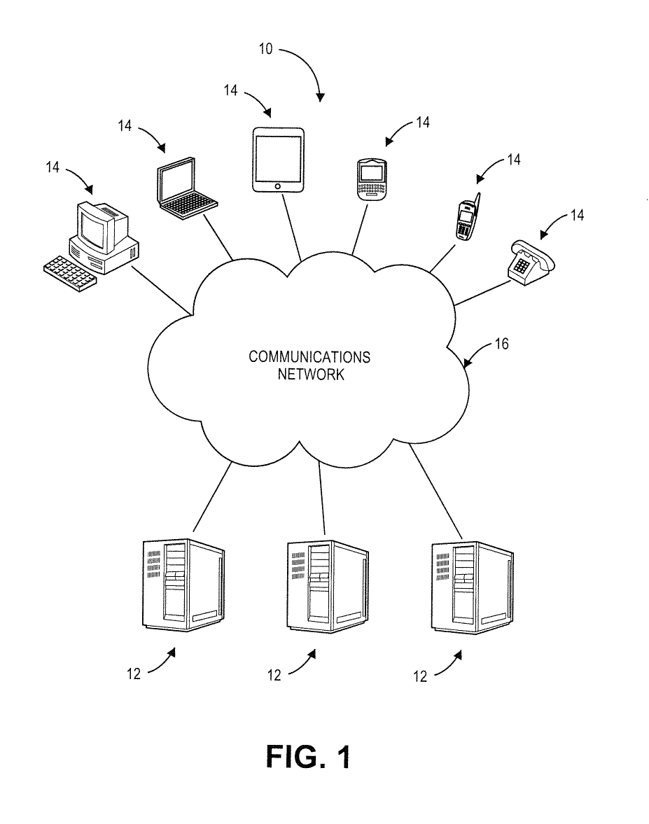

The computer program and the method of embodiments of the present invention may be implemented in hardware, software, firmware, or combinations thereof using the medical treatment information system 10, shown in FIG. 1, which broadly comprises server devices 12, computing devices 14, and a communications network 16. The server devices 12 may include computing devices that provide access to one or more general computing resources, such as Internet services, electronic mail services, data transfer services, and the like. The server devices 12 may also provide access to an electronic library (also known as a database), which stores the medical treatment information.

The computing devices 14 may include any device, component, or equipment with a processing element and associated memory elements. The processing element may implement operating systems, and may be capable of executing the computer program, which is also generally known as instructions, commands, software code, executables, applications, apps, and the like. The processing element may include processors, microprocessors, microcontrollers, field programmable gate arrays, and the like, or combinations thereof. The memory elements may be capable of storing or retaining the computer program and may also store data, typically binary data, including text, databases, graphics, audio, video, combinations thereof, and the like. The memory elements may also be known as a “computer-readable storage medium” and may include random access memory (RAM), read only memory (ROM), flash drive memory, floppy disks, hard disk drives, optical storage media such as compact discs (CDs or CDROMs), digital video disc (DVD), Blu-Ray™, and the like, or combinations thereof. In addition to these memory elements, the server devices 12 may further include file stores comprising a plurality of hard disk drives, network attached storage, or a separate storage network.

The computing devices 14 may include work stations, desktop computers, laptop computers, palmtop computers, tablet computers, portable digital assistants (PDA), smart phones, and the like, or combinations thereof. Various embodiments of the computing device 14 may also include voice communication devices, such as cell phones or landline phones. In preferred embodiments, the computing device will have an electronic display, such as a cathode ray tube, liquid crystal display, plasma, or touch screen.

The communications network 16 may be wired or wireless and may include servers, routers, switches, wireless receivers and transmitters, and the like, as well as electrically conductive cables or optical cables. The communications network 16 may also include local, metro, or wide area networks, as well as the Internet, or other cloud networks. Furthermore, the communications network 16 may include cellular or mobile phone networks, as well as landline phone networks or public switched telephone networks.

Both the server devices 12 and the computing devices 14 may be connected to the communications network 16. Server devices 12 may be able to communicate with other server devices 12 or computing devices 14 through the communications network 16. Likewise, computing devices 14 may be able to communicate with other computing devices 14 or server devices 12 through the communications network 16. The connection to the communications network 16 may be wired or wireless. Thus, the server devices 12 and the computing devices 14 may include the appropriate components to establish a wired or a wireless connection.

The computer program of the present invention may run on the computing device or, alternatively, may run on one or more server devices 12. Thus, a first portion of the program, code, or instructions may execute on a first server device 12 or the computing device 14, while a second portion of the program, code, or instructions may execute on a second server device 12 or the computing device 14. In some embodiments, other portions of the program, code, or instructions may execute on other server devices 12 as well. For example, the medical treatment information may be stored on a memory element associated with the server device 12, such that the medical treatment information is remotely accessible for each user of the computer program. Alternatively, the medical treatment information may be stored on the memory element associated with the respective computing device 14 for the user. In embodiments where the medical treatment information is stored remotely, the user may authenticate their identity at various computing devices to access the program.

In addition, the computer program of the present invention may be operated in three or more operating states. In the first state, the computer program may operate in a stand-alone state, where the computer program functions independently of any other program and is continuously accessible by a user via the electronic resource. In a second state, the computer program may be operated in an overlay state, where the computer program functions and operates in concert with other computer programs, methods, or systems. Finally, in a third state, the computer program can be operated in an on-demand state, where the computer program is accessibly by a user via the electronic resource in a non-continuous, batch-type connection. Such an on-demand state facilitates functionality in facilities that do not provide continuous connections to an electronic resource, such as due to requirements imposed by the Health Insurance Portability and Accountability Act or other technological limitations.

### Medical Treatment Information

The medical treatment information is categorized into two distinct groups. A first group is comprised of the medical reference material and includes content related to a particular medical issue, such as an injury, disease, illness, or the like. A second group is comprised of the supplier solution material and includes content supplied by commercial suppliers that is related to the treatment of the particular medical issue. Embodiments of the present invention compile and display the medical treatment information to provide users with timely, objective, and detailed knowledge of all available medical treatment options associated with particular medical issues. All of the medical treatment information is displayed to the user in a contextualized format. Thus, as the user begins to focus on certain aspects of information, such as focusing on certain diseases or illnesses, the remaining medical treatment information that is provided and displayed to the user is similarly narrowed and focused.

The medical reference material is broadly comprised of information associated with particular medical issues and includes 1) diagnosis information that is directed to specific diseases, injuries, disorders, or illnesses; 2) treatment options directed at the particular medical issue; 3) common complications associated with the treatment options; 4) informed consent information directed to providing lists of alternative treatment options and associated complication information to patients before the treatment option is chosen or performed; 5) background lectures related to the treatment option and focused on risk reduction; and 6) motor skills lectures related to the treatment option and focused on techniques or devices used during the treatment option.

In more detail, the compiled and displayed medical reference material includes the diagnosis information, which is comprised of a comprehensive medical library that lists all potential diseases, injuries, disorders, or illnesses that are stored in the electronic library or that are otherwise available for display. The diagnosis information provides descriptive information such as patient complaints, signs, and symptoms, which can be used by a physician user to make a proper diagnosis of the particular medical issue. Additionally, the displayed diagnosis information includes a list of trials, examinations, or other tests that can be administered to a patient to further enhance the ability of the physician user to make a proper diagnosis.

After the physician user has made the diagnosis and selected the particular medical issue, the physician user can request for the present invention to display a comprehensive list of treatment options available to treat the particular medical issue. All available treatment options contained within the electronic library, or otherwise accessible by the present invention, are then made available for display. The treatment options include those options approved by the FDA, those options currently undergoing FDA testing or approval, and other off-label options that will likely never be submitted to the FDA for approval. In practice, the FDA prohibits commercial suppliers from marketing treatment options that have not been FDA approved. However, embodiments of the present invention provide that physician users are independently and proactively seeking out treatment options; therefore, the FDA regulations will not prohibit the displaying of non-FDA approved treatment options because the physicians user are proactively seeking the options out.

In addition to the listing of treatment options, other information directly related to the treatment options may also be displayed. For instance, such related information may include the average cost of the treatment options, which insurance companies provide coverage for the treatment options, the clinical history of the treatment options, and the percentage of successful treatment by the options. Other related information may include professional or physician opinions regarding the treatment options, evidence-based conclusions regarding the treatment options, any legal precedents that involve the treatment option. Finally, the related information may also include information related to the geography based usage of the treatment option, the demographic based usage of the treatment option, and recent increase or decreases in the use of the treatment options.

In conjunction with the treatment options, embodiments of the present invention will display all known common complications associated with the chosen treatment option. The treatment option and common complication lists are provided such that the physician user will have a comprehensive understanding of all treatment options and associated complications before selecting a treatment option to perform on a patient. Such understanding is required by physicians to substantiate that they are practicing with the requisite level of due care and reasonable knowledge and skill. Additionally, the physician user can use the information to notify, display to, or otherwise inform their patients of all possible treatment options and corresponding potential complications to fulfill their disclosure requirement under the FDA Act and to effect informed consent of the patient.

In addition, the compiled and displayed medical reference material includes reference lectures that are directed at specific treatment options. The background lectures are displayed to provide background references, summaries, and walkthroughs of selected treatment options. The background lectures may be displayed in textual, audio, video, or any other available format. The purpose of the background lectures is to provide the user with information related to the treatment option to reduce the inherent risk associated with each treatment option. The motor skills lectures are displayed to summarize techniques and to provide equipment and device insights for use with particular treatment options. The motor skills lectures provide knowledge to the user that reduce procedural time and increase patient safety.

The computer program, method, and system of the present invention additionally compiles and displays supplier solution material that is directed to information and products supplied by commercial suppliers and that are used to treat the particular medical issue. The displayed supplier solution material is presented in a contextualized format that is directly relevant to the medical reference information and the particular medical issue being focused on and reviewed by the user. For instance, as the user begins to focus on certain aspects of information, such as on certain diseases or illnesses, the displayed supplier solution material is similarly narrowed and focused. The supplier solution material is broadly comprised of 1) lists of available pharmaceutical suppliers and drugs; 2) lists of available medical equipment; 3) lists of available medical devices; and 4) reference articles relating to supplier solution and products.

In more detail, the compiled and displayed supplier solution material is provided by commercial suppliers and includes information related to commercial medical treatment products. The computer program, method, and system of the present invention make the supplier solution material available for display by listing supplier solutions in a linkable display format. The physician user can then select the supplier solution link that they wish to view, and in response, the selected supplier solution material is displayed to the user. The supplier solution material includes commercial medical treatment products that can be used with treatment options to treat particular medical issues and also includes testing products or locations that can facilitate patient testing and diagnosis. Each supplier solution link is provided in a list format, including primary and alternative solutions, such that each supplier solution is concurrently available to be displayed to the user. Thus, the supplier solution material provides exposure to all supply, device, and pharmaceutical alternatives that are currently available.

In addition to the listing of supplier solutions, other information directly related to the supplier solution may also be displayed. For instance, such related information may include the average cost of the supplier solution, which insurance companies provide coverage for the supplier solution, the clinical history of the supplier solution, and the percentage of successful treatment by the supplier solution. Other related information may include professional or physician opinions regarding the supplier solution, evidence-based conclusions regarding the supplier solution, any legal precedents that involve the supplier solution. Finally, the related information may also include information related to the geography based usage of the supplier solution, the demographic based usage of the supplier solution, and recent increase or decreases in the use of the supplier solution.

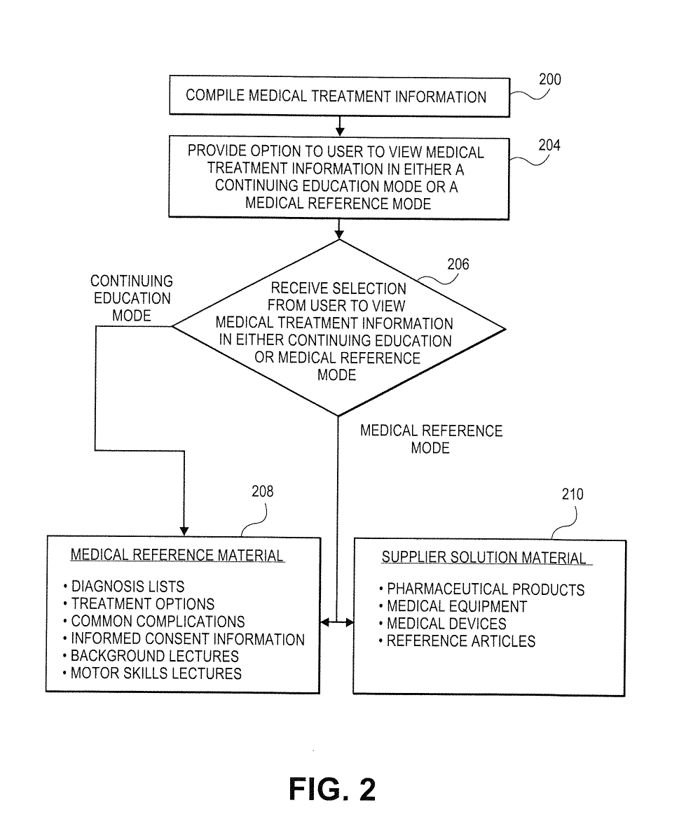

As noted above, the computer program of the present invention comprises a plurality of code segments that implement the method of the present invention. The steps of the method may be performed in the order shown in FIG. 2, or they may be performed in a different order. Furthermore, some steps may be performed concurrently as opposed to sequentially. Also, some steps may be optional. In addition and as noted above, some of the steps listed may be part of the computer program of the present invention.

Referring to FIG. 2, the method of embodiments of the present invention initially compiles all available medical treatment information, as set forth in step 200. Next, the user is provided an option to view the information in either a medical reference mode or in the continuing education mode, as set forth in step 204, and a selection from the user is received by the computer program of embodiments of the present invention, as set forth in step 206. If an input from the user is received to view the medical treatment information in the medical reference mode, all of the medical treatment information will be displayed, including medical reference material 208 and supplier solution material 210. The medical reference mode is generally chosen by a user when preparing for a medical case to treat a patient or for other general reference purposes. However, the medical reference mode may also be selected when the user wished to display medical treatment information for use by colleagues or employees for training and education purposes. Embodiments of the present invention permit the user to search for and select the particular medical issue, and thereafter will display all of the medical reference material related to the particular medical issue. Further, while the medical reference material is being displayed, the supplier solution material, or at the least information identifying supplier solutions, may also be available for display. Thus, while the user is reviewing the medical reference material, the user can choose for the system to display the supplier solution material to gain knowledge and information as to the commercial supplier products available to treat, or that are otherwise directed at, the particular medical issue.

In further embodiments of the present invention, if the computer program, method, and system receive an input 206 to display the medical treatment information in the continuing education mode, only the medical reference materials 208 will be displayed. Such a mode is generally selected when the user is participating in accredited continuing medical education requirements. In the continuing education mode, the computer program, method, and system display only the medical reference material, and the supplier solution is not available to be displayed or accessed. Therefore, while the user is participating in the CME requirement, the user is not subject to potential bias from commercial suppliers that are marketing pharmaceuticals, devices, or equipment to the users.

In even further embodiments of the present invention, the system may display information in a compliance mode, wherein the compliance mode is for displaying the information to patient users. For instance, while in the compliance mode, the computer program displays a patient version of the medical reference material, including a patient version of the treatment options and a patient version of the background and motor skills lectures. The patient version of the medical reference material provides patients with information in a format that is informative, yet understandable to a non-expert. The patient version of the medical reference materials can be used by the physician user to display information to patients to facilitate the physician user's requirements to comply with the Patient Protection & Affordable Care Act, which requires that physicians inform the patient of all treatment options and common complications prior to treatment. In some embodiments, the information may be displayed in a format that includes additional information related to each medical reference material or supplier solution, such as success rates, costs, FDA approval levels, or other relevant information.

### Compiling and Updating Information

As described above, the medical treatment information may be stored locally or remotely in an electronic library, but in preferred embodiments, the medical treatment information is stored remotely so as to allow access by the user by multiple computing devices via the electronic resource, such as a website or mobile application. In embodiments of the present invention, the medical treatment information is also password protected or requires some form of authentication to access it. This prevents a hacker from easily accessing the medical treatment information and modifying it to include inaccurate or harmful information.

Further embodiments of the present invention may utilize a search utility that scours the Internet and other electronic sources of information to find new sources of or updates to medical treatment information. As such information is located, the information may be added to the electronic library, or alternatively, topical summaries may be obtained and web links to the information may be displayed to direct the user to the location of the information. In even further embodiments, the information found via the search utility maybe directly displayed through embodiments of the present information, such that the user will not have to leave or exit embodiments of the present invention to view the information through a separate computer program or interface. For instance, if the search utility discovers information, but the information is not added to the electronic library, embodiments of the present invention may provide for the information to be displayed directly to the user through any of the embodiments described below in the Operation section.

Embodiments of the present invention provide that the medical reference material and updates thereto may be received from expert authors. Expert authors are experts in the medical field and may include physicians, academic medical centers, and physician membership organizations. To incentivize expert authors to provide reference material, the present invention provides that expert authors that participate in submitting reference materials are remunerated for submitting such reference material. Specifically, remuneration is based on the total revenue earned for a particular medical issue and is further dependent on the amount of reference material received for the particular medical issue. In some embodiments, the total revenues are revenues that are received from commercial suppliers for the opportunity to, through the present invention, submit and display supplier solution material and links thereto. Therefore, each expert author receives remuneration for each submitted reference material, but the amount of remuneration is dependent on the overall amount of reference material associated with the particular medical issue that is compiled in the electronic library. This method of remuneration incentivizes the expert authors to provide more and more content, thereby promoting diversity and objectivity in the medical treatment information being submitted.

In further embodiments of the present invention, users may comment or peer rate the material supplied by expert authors. In such an embodiment, the user will be permitted to promote and advance those materials that they believe to be most beneficial and effective. Additional embodiments of the present invention provide that when peer rating or other related metrics are utilized, expert authors may receive bonuses or additional compensation based upon the number of times their submitted information is viewed, their peer rating, or other related parameters. In further embodiments, an academic or employment entity affiliated with the expert author may also receive remuneration based upon the expert author's submitted material.

As with the medical treatment information provided by expert authors, or that is otherwise contained in the electronic library, the information obtained through the search utility may be peer rated or ranked in order to provide the users with information and support regarding the utility and effectiveness of the content. Such peer rating or ranking may be obtained from medical related sources such as physician advisory boards, physician participated reviews, or other outcome driven resources.

The supplier solution material is compiled and updated from commercial suppliers, which deposit all of the supplier's product-related marketing and technical material into the system. The commercial suppliers provide all supplier solution material that is currently available, including material related to products and solutions that have been and have not been approved by the FDA. The system organizes and displays the material in such a way that the most recent supplier solution materials are displayed in a highlighted format so as to distinguish them from older materials. For instance, the most recent material, or the links thereto, may be displayed in unique font, such as bolded, italicized, or differently colored. Further, the most recent material may be displayed in a unique position that is before or above the older material, so as to inform the user that the present material is the most current. Embodiments of the present invention thus provide a marketing avenue that allows the commercial suppliers to deliver current product related technical resources necessary to inform physicians of the most up-to-date medical treatment options, while avoiding the potential bias. Additionally, the reference articles of the supplier solution material may be provided or updated by expert authors. If the expert authors provide the reference articles, they may be remunerated based on the same formula described above for the medical reference material. As with the medical reference material, the supplier solution material may be peer rated or ranked in order to provide the users with information and support regarding the utility and effectiveness of the content.

In further embodiments of the present invention, the expert authors may provide their background information, which may include information pertaining to their backgrounds and experience such as a name, a biography, a resume, a photograph, and a description of their medical specialty. Such information may be concurrently displayed along with the medical treatment information that was received from the expert author.

As described above, the medical reference material may be used for general medical reference or to fulfill CME requirements. For the medical reference material to qualify as a CME requirement, the content and the format of the medical reference material must be accredited by an accreditation entity with authority to sponsor and accredit medical reference material for CME purposes. Such accreditation entities include medical centers, medical education companies, physician membership organizations, or other medical education providers sanctioned by the ACCME.

### Additional Features

Embodiments of the present invention further provide a social media component whereby the system facilitates communication and networking between a social network group of users. Such social network users include physicians and their corresponding medical organizations and academic institutions. The social network user can interact through social media functions contained within the computer program, method, and system, including interactive forums, RSS feeds, email, and information search functions. The social media component permits social network users to identify trends, collect data related to behavioral patterns, and identify and establish treatment methods. Thus, the social media component uniquely provides an objective risk reduction and patient safety management tool. Further, the social media component of the present invention will permit the building of profiles and targeted activities for social network users, such activities including email distributions for important medical related announcements. Finally, the social medical component will include a peer forum that allows for success and experience related commentaries as well as a supplier brand management tool.

In further embodiments of the present invention, the social media component will facilitate physician users to simply and quickly search for and publish opinions, new techniques, queries for consultations, referrals, second-opinions, and recommendations to other physician users. Such capabilities can be refined and focused so that the information will be directed at specific groups of users. Such focusing can include limiting by specialty, geography, membership to specific organizations or employers, etc. Further, such focusing can be based on social media groups that were inherently created by users within the social media component.

In even further embodiments of the present invention, the metrics associated with the use of the computer program, method, and system may be saved and documented in a database. The metrics may include all information and materials displayed and timestamps for documenting when such information was displayed and reviewed. The metrics may be used for physician user needs, such as for consultations, referrals, second opinions, or patient reviews. The metrics can further be used by physicians, their respective medical institutions, or their attorneys to provide background and support for medical or legal issues. Such issues may include controversies regarding standard of care, malpractice, or compliance standards. For instance, embodiments of the present invention provide for the documenting of each of the CMEs in which the physician user has participated. Such information could provide support for the physician having the requisite knowledge in a particular field of practice. Additionally, embodiments of the present invention include documenting all of the medical reference information that was displayed and viewed by the physician user and/or a patient user. Such documentation can be used to substantiate that the physician user reviewed all medical treatment options and their common complications and provided such information to their patient as required by applicable laws and regulations.

In even further embodiments of the present invention, system metrics can be provided to advertising agencies or insurance carriers to identify physician trends based upon the medical treatment information submissions and other user activity. This information can be provided to marketing agencies that charge a premium to clients for delivering messages to qualified target audiences. Additionally, the information can be used by insurance carriers to adjust premiums and physician training based on trends determined through the provided metrics. For instance, if a physician user has participated in a substantial number of CMEs or has reviewed a significant amount of medical treatment information, the physician user's insurance carrier may offer discount on premiums.

In even further embodiments, the present invention may be integrated with electrical medical record (EMR) management tools. EMR management tools are used by physicians and other medical service providers to document and manage patient health histories and corresponding records. In some embodiments, the computer program of the present invention may include an application program interface (API) that allows a user's EMR management tool to be integrated with the present invention, such that information may be passed back and forth between the present invention and the EMR. For instance, patient information from contained in an EMR may be transferred to embodiments of the present invention where the information can be used by physician users to aid in determining diagnoses. Additionally, many EMR management tools require that patients complete certain diagnostics tests before any further patient information can be input into the EMR. In such instances, the EMR can interface with the present invention, such that the present invention will provide lists of equipment, devices, and locations of facilities where the tests may be taken. In even further embodiments of the present invention, the API interface may facilitate the transfer of information from the present invention to the EMR, such that the EMR can be automatically populated with information that was determined and displayed in the present invention. Such information may include certain aspects of the medical reference material and supplier solutions material that was applicable to the patient or the patient's particular medical issue.

### Operation

In embodiments of the present invention, each user would be provided with a personalized log-in that would uniquely identify the user. The user must enter the log-in information to access the embodiments of the present invention. In addition, for physician users, the user may assign certain identification numbers for each patient. By entering the patient identification number into the present invention, all medical treatment information reviewed by the physician user with respect to each patient may be documented and recorded. Such documentation can be used by the physician user to demonstrate that the physician user has adhered to the standards of care required for physicians. Further, the documentation can be used to demonstrate the physician users provided their patients with all medical treatment options and common complications as required by legal and compliance standards. In other embodiments, the present invention may include one or more code segment(s) that provides the computer program with the ability to learn a users' preferences. In such an embodiment, after a user has started using the computer program, the computer program may optimize the information being displayed to the user. Such optimization may include focusing the information being displayed based on physician's specialties, treatment preferences, or other pertinent traits.

In embodiments of the present invention, the medical treatment information is displayed by a plurality of viewing areas on the electronic display of the computing device. In some embodiments, at least five viewing areas are presented to the user, such that each viewing area displays different elements of the embodiments of the present invention. A first viewing area 300 displays the mode options with which the user is provided. The user may then interactively select the mode the user desires to use. After the user has selected the mode, the selected mode is displayed to ensure the user knows what mode is currently operating. For instance, in certain embodiments, the first viewing area may display that the user is either using the present invention in the continuing education mode (ACCME Compliant) or in the medical reference mode (Reference/Preparation). Additionally, the first viewing area will display topic information related to the medical reference material in a linkable text format. For instance, in some embodiments of the present invention, the first viewing area will display the five main topics comprising the medical reference material, including diagnosis information, treatment options, common complications, patient education, and lectures. In further embodiments, the user may obtain a preview of the medical reference material. For instance, the preview may be displayed when the user orientates a pointing device of the computing device, such as a computer mouse, over the linkable display of the topic information. Such a preview is generally known in the art as a mouse-over display. Thus, in embodiments that incorporate a mouse-over display, the user can preview the available material before the material is actually displayed in the second viewing area, as described below.

After the user has selected the topic to be viewed, the content contained in the medical reference material will be displayed in a second viewing area 302. The second viewing area is the largest viewing area, making it preferable to display large amounts of information. The user can change the content being displayed by selecting another topic from the first viewing area. Upon selecting a new topic, the content of the new topic will be displayed in the second viewing area. The second viewing area may also contain linkable direction icons that facilitate the flow of information being displayed, such that the user can efficiently traverse through the information. At anytime, the user can pause the content being displayed in the second viewing area, such that the user can stop viewing the content and resume viewing at a later time.

A third viewing area 304 contains information related to the content being viewed in the second viewing area. Such content may include a coursework map, title, headings, page number, etc. Additionally, the third viewing area may display the background information associated with the expert author who contributed to the medical reference material being displayed.

A fourth viewing area 306 displays the links to the supplier solution materials. The fourth viewing area contains links for primary and alternative options of supplier solutions material. For instance, the fourth viewing area will display links to primary and alternative supplier solution material topics, including pharmaceutical drugs, medical equipment, medical devices, and related reference articles. Once the user selects the topic to be viewed, the selected supplier solution material may be displayed in the fourth viewing area, replacing the links. If the user was originally viewing medical reference information in the second viewing area and chooses to have supplier solution material displayed, the medical reference material that is currently being viewed will be paused while the supplier solution material is displayed. After the user is done viewing the supplier solution material, the user can once again resume viewing the medical reference material at the point where the user left off. This functionality is only available during use in the medical reference mode. During the continuing education mode, the fourth viewing area does not display supplier solution material links, and supplier solution material is not available to be displayed.

In further embodiments, a user may select supplier solution material to be viewed and may choose to have the material displayed in the second viewing area. In even further embodiments, the user may obtain a preview of the information contained within the supplier solution material. For instance, this preview may be displayed when the user moves a pointing device over the supplier solution material link. The preview may be in the form of a mouse-over display. Thus, in embodiments that incorporate a mouse-over display, the user can preview the available material before the material is actually displayed or selected.

A fifth viewing area 308 is used to display the social media components of the present invention. For instance, the fifth viewing area will display and provide access to the forums, RSS feeds, email, and search functions. Additionally, the user may select to pause the information currently being displayed in the second viewing area and instead have the social media components displayed in the second viewing area. The larger size of the second viewing area may provide for easier readability and use of the social media functions.

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A non-transitory computer readable storage medium with an executable program stored thereon for providing access to medical treatment information via an electronic resource, wherein the program instructs a processor to perform the following steps:
compile medical reference material accessible via the electronic resource, wherein said medical reference material comprises information related to at least one of the following: diagnoses, treatment options, common complications, patient education, and lectures;
compile supplier solution material accessible via the electronic resource, wherein said supplier solution material comprises information related to at least one of the following: pharmaceutical products, medical equipment, medical devices, and reference articles;
provide an option to a user to view medical treatment information accessible via the electronic resource in either a continuing education mode or in a medical reference mode;
receive information indicative of a selection from the user to view medical treatment information in one of said medical reference or continuing education modes;
display both the medical reference material and the supplier solution material upon receipt of the user's selection to view medical treatment information in the medical reference mode;
display only the medical reference material and do not display the supplier solution material upon receipt of the user's selection to view medical treatment information in the continuing education mode.

2. The computer readable storage medium of claim 1, wherein the steps of compiling medical treatment information further includes receiving the medical treatment information from expert authors or commercial suppliers and storing the information in an electronic library.

3. The computer readable storage medium of claim 2, wherein the most recently received supplier solution material is displayed in a highlighted format that distinguishes the recent material from previously received material.

4. The computer readable storage medium of claim 2, wherein the expert authors are remunerated based on a formula that is dependent on an amount of medical treatment information received from expert authors and directed to a particular medical issue.

5. The computer readable storage medium of claim 4, wherein the expert authors are further remunerated based on a number of times their submitted medical treatment information is viewed or a peer rating level the submitted medical treatment information has achieved.

6. The computer readable storage medium of claim 1, wherein metrics associated with the use of the computer program are documented and recorded.

7. The computer readable storage medium of claim 6, wherein the metrics are documented and recorded so as to provide medical, legal, and compliance support to the user.

8. The computer readable storage medium of claim 6, wherein metrics are provided to at least one of: advertising agencies, marketing companies, or insurance carriers for marketing, advertising, or communications purposes.

9. The computer readable storage medium of claim 1, wherein the computer program includes an application program interface that facilitates communication between the computer program and an electrical medical record management tool.

10. The computer readable storage medium of claim 1, wherein the computer program instructs the processor to further provide an interactive social forum, a search function, an RSS feed, and a messaging function.

11. The computer readable storage medium of claim 10, wherein metrics associated with the use of the interactive social forum, search function, RSS feed, and messaging function are stored and analyzed to establish treatment, reference, and peer influence trends.

12. A non-transitory computer readable storage medium with an executable program stored thereon for providing access to medical treatment information via an electronic resource, wherein the program instructs a processor to perform the following steps:
compile medical reference material accessible via the electronic resource, wherein said medical reference material comprises information related to at least one of the following: diagnoses, treatment options, common complications, patient education, and lectures;
compile supplier solution material accessible via the electronic resource, wherein said supplier solution material comprises information related to at least one of the following: pharmaceutical products, medical equipment, medical devices, and reference articles;
compile a patient version of the medical reference material accessible via the electronic resource, wherein said patient version of medical reference material comprises information related to at least one of the following: a patient version of treatment options and a patient version of lectures;
provide an option to a user to view medical treatment information accessible via the electronic resource in either a continuing education mode, a medical reference mode, or a compliance mode;
receive information indicative of a selection from the user to view medical treatment information in one of said medical reference, continuing education, or compliance modes;
display both the medical reference material and the supplier solution material upon receipt of the user's selection to view medical treatment information in the medical reference mode;
display only the medical reference material and do not display the supplier solution material upon receipt of the user's selection to view medical treatment information in the continuing medical education mode.
display only the patient version of the treatment options and the patient version of the lectures upon receipt of the user's selection to view medical treatment information in the compliance mode.

13. The computer readable storage medium of claim 12, wherein the steps of compiling medical treatment information further includes receiving the medical treatment information from expert authors or commercial suppliers and storing the information in an electronic library.

14. The computer readable storage medium of claim 13, wherein the most recently received supplier solution material is displayed in a highlighted format that distinguishes the recent material from previously received material.

15. The computer readable storage medium of claim 13, wherein the expert authors are remunerated based on a formula that is dependent on an amount of medical treatment information received for a particular medical issue.

16. The computer readable storage medium of claim 12, wherein metrics associated with the use of the computer program are documented and recorded.

17. The computer readable storage medium of claim 16, wherein the metrics are documented and recorded so as to provide medical, legal, and compliance support to the user.

18. The computer readable storage medium of claim 16, wherein metrics are provided to advertising agencies, marketing companies, or insurance carriers for marketing, advertising, or communications purposes.

19. The computer readable storage medium of claim 12, wherein the computer program instructs the processor to further provide an interactive social forum, a search function, an RSS feed, and a messaging function.

20. The computer readable storage medium of claim 19, wherein metrics associated with the use of the interactive social forum, search function, RSS feed, and messaging function are stored and analyzed to establish treatment, reference, and peer influence trends.
